(19) United States
(12) Patent Application Publication
(10) Pub. No.: US 2017/0053719 A1
(43) Pub. Date: Feb. 23, 2017

(54) CATALYST FOR ACTIVE HYDROGEN RECOMBINER AND PROCESS FOR MAKING THE CATALYST

(71) Applicant: CCI Thermal Technologies Inc., Edmonton (CA)

(72) Inventors: Jarek SZYNKARCZUK, Edmonton (CA); Leigh DICKOUT, Edmonton (CA); Syed Sameen ZAIDI, Edmonton (CA); Yaning HU, Estevan (CA)

(21) Appl. No.: 14/852,809

(22) Filed: Sep. 14, 2015

(30) Foreign Application Priority Data
Aug. 18, 2015 (CA) 2900777

(51) Int. Cl. G21C 19/317; B01J 23/42; G21C 9/06; B01J 35/00; B01J 37/08; B01J 37/02; B01J 23/44; B01J 8/02

(52) U.S. Cl. CPC G21C 19/317; B01J 23/44; B01J 23/42; B01J 8/02; B01J 35/0006; B01J 37/08; B01J 37/0219; G21C 9/06; B01J 2208/00893

(57) ABSTRACT

A process of producing a catalyst entails providing an alumina substrate and adhering a noble metal consisting of either platinum or palladium to an outer surface of the alumina substrate to form a surface coating without penetrating into a central portion of the substrate. The noble metal may be calcined in a presence of organic compounds that increase the viscosity of a liquid carrying the noble metal to thereby minimize penetration into the central portion of the substrate and that also increase the yield of metal oxides during calcination thereby making the catalyst more active.

### CROSS-REFERENCE TO RELATED APPLICATIONS

The present patent application/patent claims the benefit of priority of Canadian Patent Application No. 2,900,777 filed Aug. 18, 2015, and entitled “CATALYST FOR ACTIVE HYDROGEN RECOMBINER AND PROCESS FOR MAKING THE CATALYST,” the contents of which are incorporated in full by reference herein.

### TECHNICAL FIELD

The present invention relates generally to hydrogen recombiners and, in particular, to catalysts for a hydrogen recombiner.

### BACKGROUND

In a nuclear power plant, there are a number of potential sources of hydrogen production. Under normal conditions, hydrogen is continuously generated by the radiolysis of water and metal corrosion. Over time, this can reach flammability limits. During an incident in the nuclear reactor core, such as a loss-of-coolant accident (LOCA), a large amount of hydrogen is released that can cause an instantaneous explosion in the presence of oxygen, and elevated temperature. Hydrogen is also produced due to radiolysis of process water in medical isotope production facilities, waste storage fuel transport containers, and thermonuclear fusion reactors. To mitigate the build-up of hydrogen concentration to dangerous limits, active or passive hydrogen recombiners are used. A recombiner uses a catalyst made of porous material treated with noble metals such as platinum and/or palladium. The catalyst provides sites where hydrogen and oxygen come into close vicinity and chemically react to form water, thus reducing hydrogen concentration.

The Fukushima nuclear power plant incident in Japan gained the attention of the nuclear community on the threat of containment posed by a significant release of hydrogen and oxygen into a containment building. In order to address hydrogen accumulation in a containment building, the catalytic oxidation of hydrogen to water vapour can be achieved with catalytic, passive or active hydrogen recombiners. This strategy is based on catalytic oxidation of hydrogen, by re-using process air. The product of hydrogen oxidation reaction is water vapour and heat generation. The catalyst will not be consumed in this process.

The majority of literature available on the topic of hydrogen recombination refers to passive autocatalytic recombiners (PAR). Passive recombiners contain a proprietary catalyst attached to the sheet metal substrate. Once hydrogen is generated it passes via PAR whereby hydrogen is neutralized to water vapour. It is a passive device that requires neither power nor moving parts. They are also located in the proximity of a nuclear reactor. There are commercially available passive autocatalytic recombiners.

Active recombiners require forced convection, e.g. a pump or compressor to move gaseous products of a nuclear reaction, including hydrogen, to an active recombiner. This recombiner is usually not located in the containment area. This type of recombiner contains a catalyst in the form of cylinders, spheres, etc. There are commercially available catalysts for active recombiners. The catalyst comes in a cylindrical shape.

A more efficient catalyst capable of operating over a wide range of conditions remains highly desirable.

### SUMMARY

Disclosed herein is a catalyst for an active hydrogen recombiner and a process for making the catalyst. In one embodiment, the catalyst is platinum (Pt) based and in another embodiment the catalyst is palladium (Pd) based. In both of these embodiments, the catalysts are highly active catalysts for hydrogen oxidation. In each embodiment, the catalyst is not deactivated by high humidity, steam or radiation. The catalyst is furthermore active over a wide range of temperatures.

Accordingly, one inventive aspect of the present disclosure is a process of producing a catalyst, the process comprising an alumina substrate and adhering a noble metal consisting of either platinum or palladium to an outer surface of the alumina substrate to form a surface coating without penetrating into the central portion of the substrate (egg-shell configuration).

Another inventive aspect of the present disclosure is a catalyst comprising an alumina substrate and a noble metal consisting of either platinum or palladium, the noble metal adhering only to an outer surface of the alumina substrate to form a surface coating without penetrating into a central portion of the substrate.

Yet another inventive aspect of the present disclosure is an active hydrogen recombiner for use in a moderator of a nuclear power generation plant. The recombiner comprising an inlet for receiving gaseous mixture from a calandria of the moderator, the mixture containing hydrogen and a recombination chamber containing a catalyst wherein the catalyst comprises an alumina substrate and a noble metal consisting of either platinum or palladium, and the noble metal adhering only to the outer surface of the alumina substrate to form a surface coating without impregnating into a central portion of the substrate. The recombiner also includes an outlet for returning the oxidation product, i.e. water vapour back into the cooling system.

This summary is provided to highlight certain significant inventive aspects but is not intended to be an exhaustive or limiting definition of all inventive aspects of the disclosure. Other inventive aspects may be disclosed in the detailed description and drawings.

### BRIEF DESCRIPTION OF THE DRAWINGS

Further features and advantages of the present invention will become apparent from the following detailed description, taken in combination with the appended drawings, in which:

FIG. 1 schematically depicts a moderator system having an active hydrogen recombiner that uses a catalyst to recombine hydrogen;

FIG. 2 is a flowchart outlining main steps of a process of making the catalyst; and

FIG. 3 depicts a spherical catalyst with an outer skin composed of a noble metal (egg-shell configuration).

It will be noted that throughout the appended drawings, like features are identified by like reference numerals. It should furthermore be noted that the drawings are not necessarily to scale.

### DETAILED DESCRIPTION

In general, the embodiments of the present invention provide a process for making a catalyst that has superior performance characteristics. The catalyst operates over a wider range and requires less noble metal to accomplish the recombination of hydrogen than prior-art catalysts.

Depending on the ratio of palladium or platinum to substrate material, the novel catalysts are water-resistant and able to react to recombine hydrogen over a wide hydrogen concentration, e.g. 0%-6%. This also provides superior performance at higher hydrogen concentrations. Typically the hydrogen mixture concentration is not higher than 4%. Over this point its mixture may explode as it is over the lower explosive limit (LEL). At higher concentrations of hydrogen more heat is generated. The excessive heat could cause the hydrogen to explode as soon as it reaches higher concentration level (i.e. above LEL), and would sinter, destroy and/or melt the catalyst. At higher concentrations of hydrogen, it is recommended to use a water trickle bed recombiner. In this configuration, water is injected intermittently with hydrogen/air gas mixture, concurrently to the recombiner. Water can remove generated heat by three ways: sensible, latent, and super heat. In this configuration hydrogen removal concentration can be extended from its upper limit of 4%-6% all the way up to 25%.

Due to very high catalyst activity you need 30% (wt.)-50% (wt.) less of the novel catalyst to achieve the same results as a leading prior-art catalyst.

In one embodiment, the catalyst is in the form of ⅛″-diameter spheres although it will be appreciated that other size spheres or other shapes may be employed in other embodiments. The shape of the spheres will produce a low pressure drop compared with the current commercially available cylindrical catalyst. In this embodiment, the catalyst is also water-resistant.

The presence of radiation, equivalent to 100 years of service, does not influence the performance of the catalyst. The catalyst is able to work below 1% of H₂ while a comparable prior-art catalyst would be deactivated at this level.

The catalyst contains, in one embodiment, 0.3% of noble metals (Pd or Pt) on the alumina substrate. In the process the catalyst is placed on the very top layer of the alumina substrate, e.g. on the alumina spheres (or any other suitably shaped substrate, e.g. oval-shaped substrate). By controlling the pH and the viscosity of the solution, and by introducing oxidation agents during the impregnation/calcination process, it is possible to limit the adhesion of the catalyst to the outer surface of the alumina substrate. The outer surface is the only location that allows the catalyst to be active. Therefore, it is desirable to cause the noble metal to adhere to the outer surface of the substrate without penetrating into a central portion of the substrate.

Synthesis of the noble metal catalyst may be accomplished by impregnation of Pd (or Pt) solutions onto the alumina spheres. The metals start to impregnate on the top surface of the substrate and then gradually start to penetrate inside the sphere. By controlling the pH level and the viscosity of the liquid, the process causes the metal to adhere to the outer surface of the substrate to thereby forming a coating or layer of catalyst on the substrate.

Controlling the viscosity may be achieved by using organic compounds such as carbohydrates, e.g. monosaccharides, disaccharides and/or oligosaccharides. These organic compounds (or organic agents) increase the liquid's viscosity and force the noble metal to stay on the outer surface of the alumina spheres. In other words, this organic agent plays a twofold role in the catalyst synthesis. The organic agent not only helps in making the top layer of the catalyst but also acts as an oxidizing agent that increases the yield of noble metal oxides that are obtained during the calcination process. The presence of metal oxides on the outer surface of the substrate, during catalyst preparation, makes the catalyst more active. In one embodiment, the organic compounds act as oxidizing agents to oxidize the platinum or palladium to their oxide forms.

In some embodiments of the process, it has been found that specific calcination conditions of the catalyst is critical to obtaining its high activity. Therefore, many combinations of calcination were used and tested for performance. For a Pd-based catalyst, the finalized calcination condition was 450° C. for 2 hours then dropping the temperature to 200° C. followed by reduction under flowing 4% H₂ for 30 minutes. At the end of the reduction under flowing H₂, the catalyst was taken out of the furnace immediately in order to allow cooling to room temperature under ambient air. For the Pt-based catalyst, the calcination was finalized as 550° C. for 2 hours.

In one set of embodiments, organic agents such as carbohydrates, e.g. monosaccharides, disaccharides, and/or oligosaccharides, were used to increase the liquid's viscosity and to force the noble metal to stay on the outer surface of the alumina substrate. Those organic agents play a dual role in the catalyst synthesis. Not only do they help in making the top layer of catalyst but they also act as an oxidizing agent by increasing the yield of obtaining noble metal oxides during the calcination process. The presence of oxides make the catalyst more active.

The catalyst produced by this process is able to handle wide hydrogen/deuterium fluctuations of 0%-4%. Conventionally, it is more difficult to have a catalyst operating at a low concentration range of 0%-1%. Due to lower activity of conventional catalysts they are typically deactivated below 1%.

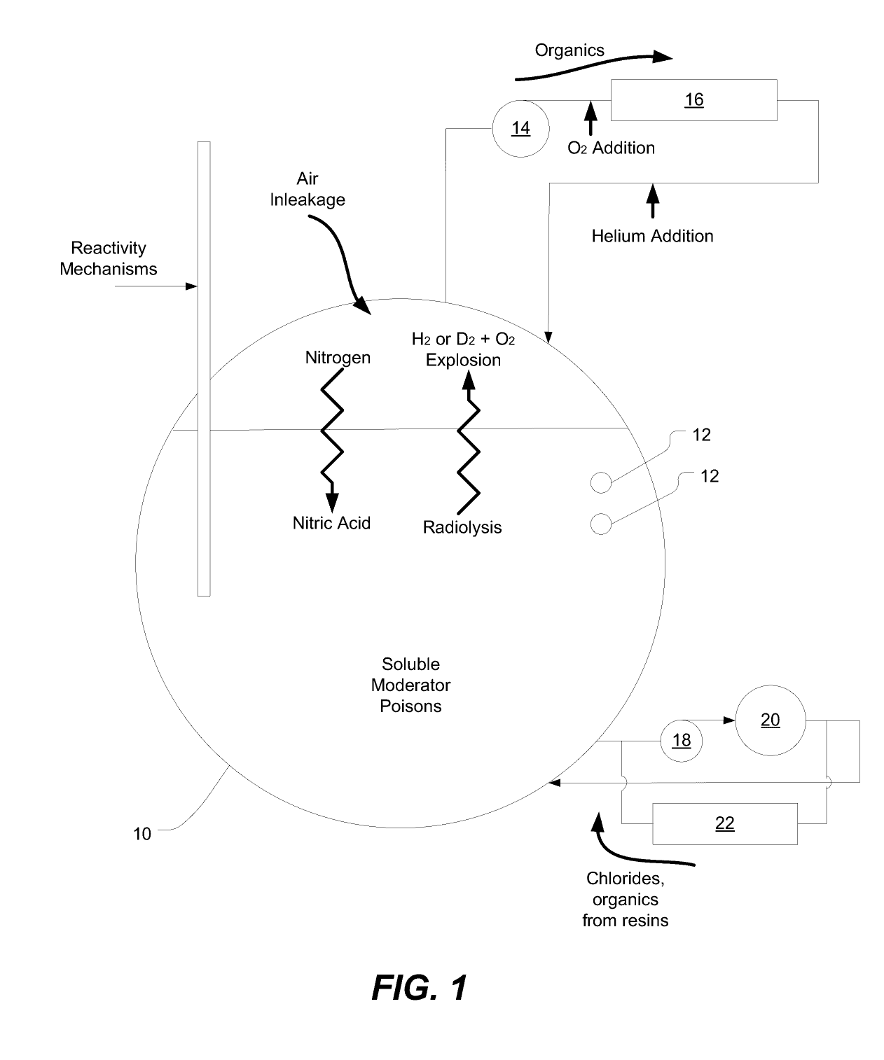

The catalyst disclosed in this specification may be used in a moderator such as the one illustrated by way of example in FIG. 1. The moderator includes a calandria 10, e.g. a stainless steel calandria, and a plurality of calandria tubes 12. As illustrated by way of example in FIG. 1, the moderator also includes a compressor 14 and a recombiner 16, i.e. an active hydrogen recombiner. In the illustrated embodiment, between the compressor and the recombiner is a first intake port for adding oxygen (O₂). Downstream of the recombiner in this embodiment is a second intake port for adding helium. As shown by way of example in FIG. 1, the moderator also has a pump 18, a heater 20, a purification circuit 22. At higher levels of hydrogen, it is recommended to use a trickle bed recombiner to remove excess heat that is generated by the highly exothermic reaction of hydrogen oxidation. The moderator of FIG. 1 may operate not only with hydrogen but also with deuterium. The recombiner 16 may utilize either a Pd-based catalyst or a Pt-based catalyst. The Pt-based catalyst is water-resistant, and self-restarts after been exposed to H₂/O₂ with or without the presence of moisture. The Pd-based catalyst or the Pt-based catalyst used in the recombiner 16 is also unaffected by radiation. The recombiner 16 is thus superior to a prior-art recombiner since it employs a more efficient catalyst.

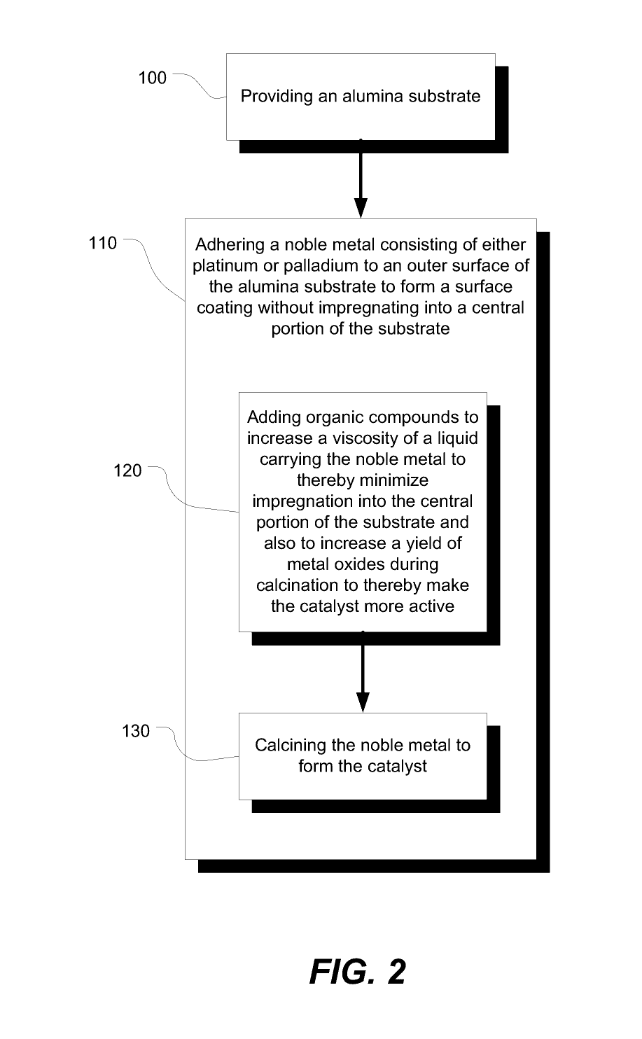

The novel process of making the catalyst is summarized in FIG. 2. The process (or method) comprises a step 100 of providing an alumina substrate. The process then entails a step 110 of adhering a noble metal consisting of either platinum or palladium to an outer surface of the alumina substrate to form a surface coating without penetrating into a central portion of the substrate. Step 110 includes a sub-step 120 of adding organic compounds to increase the viscosity of a liquid carrying the noble metal to thereby minimize penetration into the central portion of the substrate and also to increase the yield of metal oxides during calcination to thereby make the catalyst more active and a sub-step 130 of calcining the noble metal to form the catalyst. Highly viscous catalyst solution inhibits Pt/Pd penetration of aluminum washcoat. Pt/Pd ions are forced to stay more in syrupy-like liquid form and are not promoted to penetrate alumina (Al₂O₃).

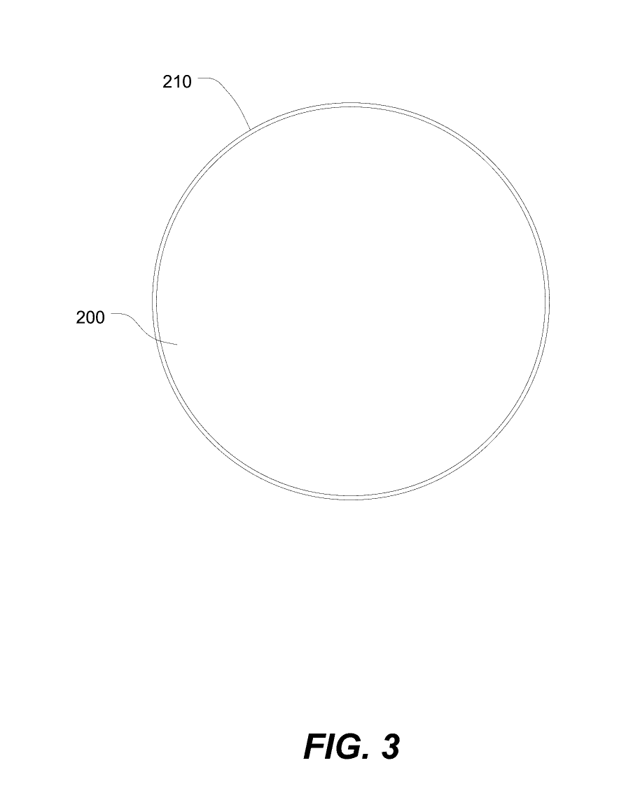

FIG. 3 depicts schematically a spherical substrate 200 having an outer surface coating 210 composed of a noble metal and/or one or more metal oxides. As illustrated by way of example in the schematic depiction of FIG. 3, the metal oxide only adheres to the outer surface and does not penetrate into the central portion of the substrate. The outer coating forms a skin. Since the noble metal does not penetrate into the central portion of the substrate, it is not wasted.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

The present invention has been described in terms of specific embodiments, examples, implementations and configurations which are intended to be exemplary or illustrative only. Other variants, modifications, refinements and applications of this innovative technology will become readily apparent to those of ordinary skill in the art who have had the benefit of reading this disclosure. Such variants, modifications, refinements and applications fall within the ambit and scope of the present invention. Accordingly, the scope of the exclusive right sought by the Applicant for the present invention is intended to be limited solely by the appended claims and their legal equivalents.

1. A process of producing a catalyst, the process comprising:
providing an alumina substrate; and
adhering a noble metal consisting of either platinum or palladium to an outer surface of the alumina substrate to form a surface coating without impregnating into a central portion of the substrate.

2. The process as claimed in claim 1 wherein the noble metal is platinum.

3. The process as claimed in claim 1 wherein the noble metal is palladium.

4. The process as claimed in claim 2 further comprising calcining the platinum at 550° C. for 2 hours.

5. The process as claimed in claim 3 further comprising calcining the palladium was calcined at 450° C. for 2 hours.

6. The process as claimed in claim 1 further comprising using organic compounds to increase a viscosity of a liquid carrying the noble metal to thereby minimize penetration into the central portion of the substrate and also to increase the yield of metal oxides during calcination to thereby make the catalyst more active.

7. The process as claimed in claim 6 wherein the organic compounds comprise one or more of a monosaccharide, disaccharide or oligosaccharide.

8. A catalyst comprising:
an alumina substrate; and
a noble metal consisting of either platinum or palladium, the noble metal adhering only to an outer surface of the alumina substrate to form a surface coating without penetrating into a central portion of the substrate.

9. The catalyst as claimed in claim 8 wherein the noble metal is platinum.

10. The catalyst as claimed in claim 8 wherein the noble metal is palladium.

11. The catalyst as claimed in claim 9 wherein the platinum was calcined at 550° C. for 2 hours in a presence of organic compounds that controlling the pH and the increase a viscosity of a liquid carrying the noble metal to thereby minimize penetration into the central portion of the substrate and that also increase the yield of metal oxides during calcination to thereby make the catalyst more active.

12. The catalyst as claimed in claim 10 wherein the palladium was calcined at 450° C. for 2 hours that controlling the pH and the increase a viscosity of a liquid carrying the noble metal to thereby minimize penetration into the central portion of the substrate and that also increase the yield of metal oxides during calcination to thereby make the catalyst more active.

13. The catalyst as claimed in claim 8 wherein the noble metal is calcined in a presence of organic compounds that increase a viscosity of a liquid carrying the noble metal to thereby minimize penetration into the central portion of the substrate and that also increase the yield of metal oxides during calcination to thereby make the catalyst more active.

14. An active hydrogen recombiner for use in a moderator of a nuclear power generation plant, the recombiner comprising:
an inlet for receiving fluid from a calandria of the moderator, the fluid containing free hydrogen;
a recombination chamber containing a catalyst wherein the catalyst comprises:
an alumina substrate; and
a noble metal consisting of either platinum or palladium, the noble metal adhering only to an outer surface of the alumina substrate to form a surface coating without penetrating into a central portion of the substrate;
an outlet for returning the fluid to the calandria after recombining the hydrogen in the recombiner.

15. The active hydrogen recombiner as claimed in claim 14 wherein the noble metal is platinum.

16. The active hydrogen recombiner as claimed in claim 14 wherein the noble metal is palladium.

17. The active hydrogen recombiner as claimed in claim 15 wherein the platinum was calcined at 550° C. for 2 hours in a presence of organic compounds that that controlling the pH and the increase a viscosity of a liquid carrying the noble metal to thereby minimize impregnation into the central portion of the substrate and that also increase the yield of metal oxides during calcination to thereby make the catalyst more active.

18. The active hydrogen recombiner as claimed in claim 16 wherein the palladium was calcined at 450° C. for 2 hours that that controlling the pH and the increase a viscosity of a liquid carrying the noble metal to thereby minimize impregnation into the central portion of the substrate and that also increase the yield of metal oxides during calcination to thereby make the catalyst more active.

19. The active hydrogen recombiner as claimed in claim 14 wherein the noble metal is calcined in a presence of organic compounds that increase a viscosity of a liquid carrying the noble metal to thereby minimize penetration into the central portion of the substrate and that also increase the yield of metal oxides during calcination to thereby make the catalyst more active.

20. The active hydrogen recombiner as claimed in claim 19 wherein the organic compounds comprise one or more of a monosaccharide, disaccharide or oligosaccharide.
